(19) United States
(12) Patent Application Publication
(10) Pub. No.: US 2008/0162507 A1
(43) Pub. Date: Jul. 3, 2008

(54) Really simple syndication (RSS) and database integration

(76) Inventors: Theodore Papaioannou, Manhattan Beach, CA (US); Richard Glick, Valley Center, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/646,657

(22) Filed: Dec. 28, 2006

(51) Int. Cl. G06F 17/30

(52) U.S. Cl. 707/100

(57) ABSTRACT

Techniques for integrating Really Simple Syndication (RSS) information into relational database information are provided. RSS information is acquired from an RSS feed in a native RSS data format. The RSS information is selective translated into the relational database information in a relational database format. The relational database information is accessible via a relational database and its interface.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the example source and/or pseudo code as described below and in any drawings hereto: Copyright© 2006, NCR Corp. of Dayton, Ohio—All Rights Reserved.

### FIELD

The invention relates generally to relational database technology processing and more particularly to techniques for integrating Really Simple Syndication (RSS) information into relational database information for use in a relational database.

### BACKGROUND

Really Simple Syndication (RSS) technology includes a series of World-Wide Web (WWW) data formats and services. The technology is used to publish frequently updated WWW pages, such as blogs, news feeds, etc. Consumers of the RSS content use special browsers referred to as aggregators. The aggregators watch for new content from perhaps dozens or even hundreds of web feeds by regularly polling those web feeds for information.

RSS data formats are typically represented in Extensible Markup Language (XML). XML divorces data content from the data presentation details. The XML file having the RSS data is often referred to as an RSS feed, web feed, RSS channel, and/or RSS channel.

Users typically subscribe to a RSS feed and then aggregator services, which are typically integrated into WWW browsers, regularly acquire the RSS information and update that information for presentation to the user. Generally, when a user visits a web page or site that supports RSS technology, the user is presented with a subscription option to subscribe to the RSS content associated with that page.

At present, RSS technology is primarily used and consumed by end users. That is, enterprises are not as likely to attempt to use and integrate RSS feeds into their enterprise data. This is so, because in order to make RSS content useful to the enterprise a variety of manual operations have to table place.

For example, the RSS feed has to be subscribed to and than a program has to be developed to take the rendered XML content acquired from the RSS feed into a format recognized by the enterprise's data management system. That translated data then has to be stored in the data management system.

Unfortunately, this process is not automated and for each different version of RSS a translation application has to be established. Moreover, each RSS feed may organize and represent its content in different manners, such that translators for each different content structure has to be developed.

It is apparent that this laborious process is not only manual but is also time and resource intensive. Additionally for an enterprise, a single or even handful of monitored RSS feeds may be of little value, if other RSS feeds are being ignored. Thus, the problem is compounded because the enterprise's thirst large and varied RSS feeds.

The problem is not exclusive to enterprises because more savvy end users may have their own data management systems and may desire to integrate RSS content into their data management system. In such a situation, the same manual effort and translations have to be implemented by the end user before successful integration into the end user's data management system can be achieved.

Accordingly, although RSS technology has become the rage on the Internet with end users that same RSS technology is largely not being used by enterprises or even some end users to any significant or useful degree, when these enterprises and end users have a need to integrate RSS content into their data management systems.

Thus, it can be seen that improved mechanisms are needed for integrating RSS technology in a more automated fashion and streamlined fashion into data management systems.

### SUMMARY

In various embodiments, techniques for Really Simple Syndication (RSS) and relational database integration are provided. According to an embodiment, a method for integrating RSS information into a database is presented. RSS information is received from an RSS feed. Next, selective elements of the information are translated into fields of a database table and the database table is made available for use via an interface associated with the database.

### BRIEF DESCRIPTION OF THE DRAWINGS

FIG. 1 is a diagram of a method for integrating Really Simple Syndication (RSS) information into a database, according to an example embodiment.

FIG. 2 is a diagram of a method for establishing and using RSS settings that permits RSS information to be integrated into database information for use in a database, according to an example embodiment.

FIG. 3 is a diagram of a RSS and relational database integration system, according to an example embodiment.

### DETAILED DESCRIPTION

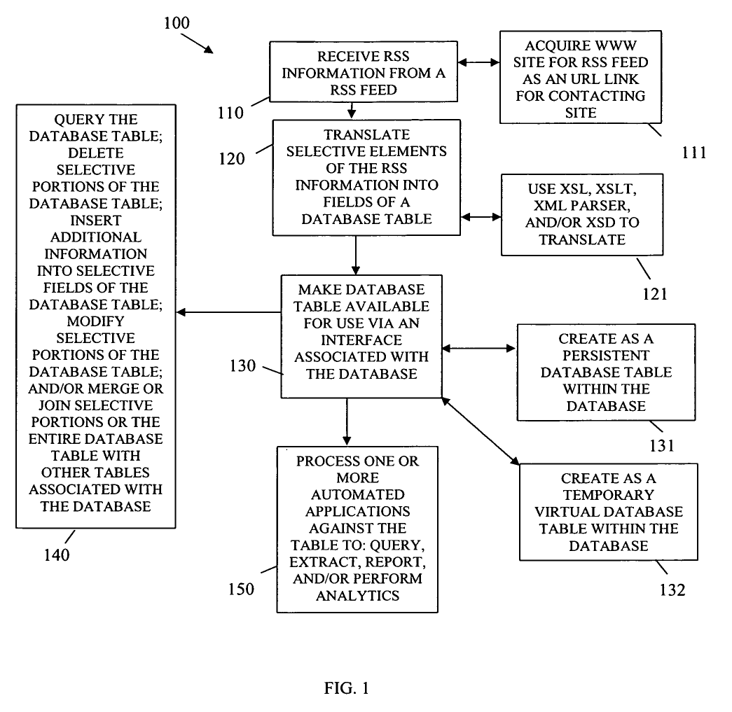

FIG. 1 is a diagram of a method 100 for integrating Really Simple Syndication (RSS) information into a database, according to an example embodiment. The method 100 (hereinafter “RSS database integration service”) is implemented in a machine-accessible or computer-readable medium as instructions that when executed by a machine (processing device) performs the processing depicted in FIG. 1. Moreover, the RSS database integration service is accessible over a network. The network may be wired, wireless, or a combination of wired and wireless.

The term “database” as used herein refers to a relational database. A database may also include a collection of databases integrated with one another as a data warehouse. According to an embodiment, the database is a Teradata® warehouse product or service distributed by NCR Corporation of Dayton, Ohio.

The phrase “RSS information” refers to RSS content received in an Extensible Markup Language (XML) formatted file. This file includes XML elements representing different types or structural relationships between elements of the XML content.

A “virtual database table” refers to a non persistent type of table or database set structure that may be consumed and manipulated by an Application Programming Interface (API) associated with a database. A “persistent table” is one that is stored and retained with the database. Both a virtual and a persistent database table can be accessed and manipulated using operations or modules associated with a database's API. According to an embodiment, the API used herein at least partially supports or includes SQL. Other used defined operations and customizations may be included in the API in any programming language, such as but not limited to C, C++, Perl, Java, etc.

It is within this context that the processing associated with the RSS database integration service is now described in detail with reference to the FIG. 1.

At 110, the RSS database integration service receives RSS information from a RSS feed. This may be achieved by acting as an aggregator and actively contacting an external server having the desired RSS information on a regular basis. The regularity of polling an RSS feed can be configured as a processing option or profile associated with the RSS database integration service.

In some situations, the RSS database integration service may interact with an existing aggregator that contacts the RSS feed on behalf of the RSS database integration service to provide the RSS information. Thus, the RSS database integration service may acquire the RSS information itself or may have a third-party service (aggregator) acquire the RSS information on behalf of the RSS database integration service.

According to an embodiment, at 111, the RSS database integration service may acquire a WWW site for the RSS feed as a Uniform Resource Locator (URL) or Uniform Resource Identifier (URI) link. The URL or URI can be activated by the RSS database integration service or by a third party service on behalf of the RSS database integration service to contact the WWW site and acquire the RSS information.

At 120, the RSS database integration service translates selective elements included in the received RSS information into fields of a database table. In some cases, at 121, the RSS database integration service may use a variety of XML related applications to assist in the translation, such as an Extensible Markup Language Style Sheet (XSL), and XSL Transform (XSLT) application, an XML parser, and/or an Extensible Markup Language Schema Definition (XSD).

The structure of the RSS elements included in the RSS information is defined in XML and may be mapped or translated to desired or selective fields of the database table. For example, an element in the RSS information as <LastName>Papaioannou</LastName> can be translated or mapped to a relational database field of “Lname.” The translation can be more complex than a simple mapping. For example, structure may be captured in a record having multiple fields. So, a particular company name, its current stock price, any profit warnings, etc. can be parsed from the XML information and housed in multiple fields of a single record within the database table.

As was mentioned above, in some situations the translation may be substantially automated with the assistance of XML tools and data structures, such as XML parsers to return elements and structure identifications from the XML information; XSL to format the information in a desired presentation format; XSLT to call custom routines or functions to handle exception or non automated translation in a seamless manner; and XSD to use in connection with the XML parser to assist in identifying context and structure represented in the XML information. Of course it is understood that custom-developed translation may also be used.

At 130, the RSS database integration service makes the database table available for use via an interface associated with the database to which the table relates. Thus, any API (including query language, such as SQL) and any custom developed application or service can use the items included in the database table using relational technology.

Thus, the RSS information is integrated into relational information and is made available for manipulation and use within a relational database environment. By doing this, enterprises having large and diverse amounts of data can seamlessly integrate RSS feeds and the corresponding RSS information into their data warehouse environments. Additionally, more savvy end users with databases can utilize the RSS database integration service to integrate RSS information into their databases for subsequent manipulation. This essentially integrates RSS technology with relational database technology in an automate fashion.

According to an embodiment, at 131, the RSS database integration service may create the database table within the database. That is, the resulting database table is permanently stored in the database until deleted or removed. A determination as to whether to persist the database table can be resolved via processing parameters, profiles, or end-user selectable options.

In still another embodiment, at 132, the RSS database integration service may create the database table as a temporary virtual database table within the database. In other words, the database table is not persistent and may stay around for some configurable period of time or until a particular policy, event, and/or condition are satisfied. Again, determination as to whether to make the database table virtual and as to the period, policy, event, and/or condition that removes the virtual table from the database can be resolved via processing parameters, profiles, or end-user selectable options. The virtual table may also be referred to as a set or view. It is a logical table that does not have to have a schema and can be dynamically assembled and provided for use within the database.

Once the database table is made available within the database or the environment of the database, at 140, the RSS database integration service can perform a variety of configured operations on behalf of a user. These operations can include, but are not limited to, querying the database table for specific information; deleting selective portions of the database table; inserting additional information into selective fields of the database table; modifying selective portions of the database table, extracting information from the table and using it as a search query against a different database table; and/or merging or joining selective portions or the entire database table with other tables associated with the database. It is noted that the RSS database integration service does not have to perform these tasks against the database table; but it can be configured to do one or more of these tasks. An end-user or other service can also perform operations and tasks similar to the ones discussed herein against the database table independent of the actions that may or may not be taken by the RSS database integration service.

In an embodiment, at 150, the RSS database integration service may call or cause to be processed one or more automated applications or services against the database table. The automated applications can perform queries, extractions, reports, database mining, and/or analytics. So, profiles or configuration settings may drive the RSS database integration service to enlist the services of automated applications to process against the database table once the RSS information is populated in relational format within the database table.

So, a variety of post processing activities can occur against the resulting information housed in the database table. The post processing can be independently achieved via subsequent and independent actions of end-users or automated services. Additionally, the RSS database integration service may perform the post processing. In still other cases, the RSS database integration service may be configured or directed to call or initiate the post processing via a third-party application or service.

It is also noted, that one or more of these post processing activities can occur, such that by doing one technique the other techniques are not precluded from also occurring. For example, the RSS database integration service may do some post processing, may enlist the services of a third-party application to do other post processing, and an end-user may elect to still do some more post processing. The point is that once the RSS information has been translated to a relational format within a relational database environment; anything subsequent processing desired against that relational data can be achieved and achieved in configurable manners.

Additionally, the post processing can be performed according to plans. That is, any particular post process can have a variety of tasks and it may be that processing managers within the database environment can perform each tasks or sub sets of tasks in different manners and perhaps using different resources. Selection of the manners and/or resources can follow a plan that drives the processing managers.

In some situations, the RSS database integration service may be operable within a parallel processing environment. In these cases, the RSS database integration service can be threaded or logically threaded so as to permit multiple processing instances of the RSS database integration service to execute on different processing units within the environment in parallel or substantially in parallel. By doing this, large database environments can utilize the RSS database integration service in a more efficient manner and improve overall performance of resources within the environment. For example, one instance of the RSS database integration service can handle designated RSS feeds and another RSS database integration service can handle other different RSS feeds. The two database tables produced by the RSS database integration services can subsequently be merged together as one database table after each instance of the RSS database integration service completes.

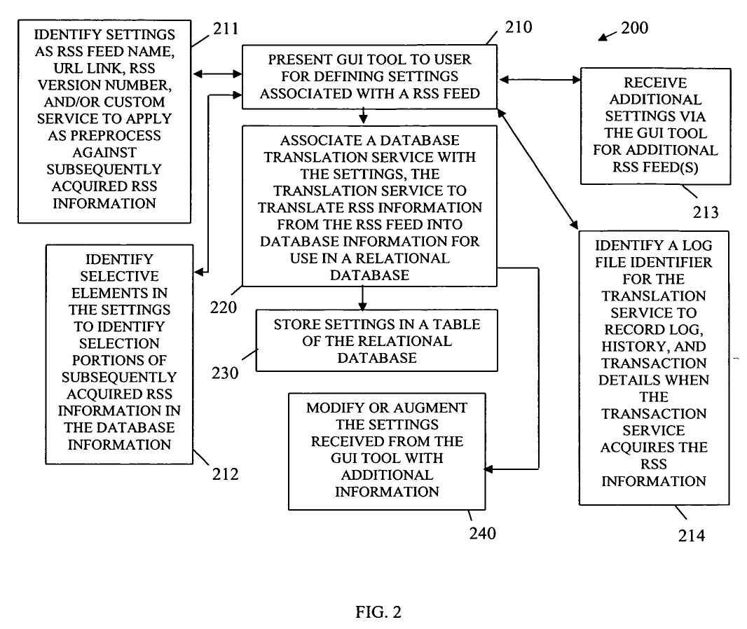

It is now appreciated how RSS feeds and their corresponding information may be integrated and made available for use within a relational database environment. This permits a mechanism for automated and seamless integration of RSS technology with relational database technology. Initial configuration of the RSS database integration service may at least partially be established via the method 200 discussed below with reference to the FIG. 2.

FIG. 2 is a diagram of a method 200 for establishing and using RSS settings that permits RSS information to be integrated into database information for use in a database, according to an example embodiment. The method 200 (hereinafter “RSS database configuration service”) is implemented in a machine-accessible and readable medium as instructions that when executed by a machine performs the processing reflected in FIG. 2. The RSS database configuration service may also be accessible over a network. The network may be wired, wireless, or a combination of wired and wireless. The RSS database configuration service prepares configuration settings that permit the perspective to the RSS database integration service, which is represented by the method 100 of the FIG. 1, to process.

At 210, the RSS database configuration service presents a Graphical User Interface (GUI) tool to a user for defining settings associated with a RSS feed. The GUI tool includes a variety of fields. Each field may permit manual user entry of information or may permit the user to select certain values of information from browsing, searching, or even selection of list items. The purpose of the GUI tool is to adequately receive RSS feed metadata, referred to as settings, that permits a database translation service to subsequently acquire RSS information from that RSS feed and translate it into relational database information for use within a relational database environment. The setting can include a variety of information and can be used for a variety of reasons.

For example, at 211, the RSS database configuration service may identify the settings as being: a RSS feed name (e.g., CNN, etc.); a RSS URL or URI (e.g., www.cnn.com, etc.,); a RSS version number (e.g., RSS 2.0 versus RSS 1.0, etc.); optionally a custom service or application to apply as a preprocess against any subsequently acquired RSS information; and the like.

In a particular situation, at 212, the RSS database configuration service may identify selective elements in the settings via reference to a file or via list entry within the settings. These selective elements identify portions of any subsequently acquired RSS information that a user wants a database translation service to extract and record in the database information for subsequent use. In other words, a particular RSS feed may have 10 elements of information in its stream of data when acquired. But, an end user may not have any use for 8 of those elements. Thus, setting values may indicate to a subsequent database translation service the 2 particular elements of interest and the remaining 8 elements are ignored.

It is also noted, at 213, that the RSS database configuration service may receive from the GUI tool a variety of additional settings associated with additional RSS feeds. So, multiple RSS feeds and their settings may be defined via the GUI tool and processed by the RSS database configuration service.

According to an embodiment, at 214, it may also be the case that the RSS database configuration service identifies within the settings a log file identifier. This is subsequently used by the database translation service to record log, history, and transaction details associated with acquiring and perhaps translating RSS feeds and RSS information. So auditing, reporting, and logging features can be integrated and identified via the settings, if desired.

At 220, the RSS database configuration service associates a database translation service with the received settings. The database translation service was discussed in detail above with reference to the RSS database integration service represented by the method 100 of the FIG. 1. Specifically, the RSS database configuration service uses the settings to subsequently acquire RSS information from the RSS feed defined in the settings and to translate the RSS information into database information that is usable in a relational database environment. That information may be persistent and in a traditional table format or it may be temporary, virtual, or logical and captured as a virtual table, view, or set.

At 230, the RSS database configuration service stores the settings in a table of the relational database. This permits the database translation service to dynamically configure itself by acquiring and reading the table for the settings at run time. Additionally, subsets of RSS feeds may be housed in different tables and the same or different database translation services may acquire the settings from those tables at runtime to acquire the RSS feeds and RSS information and to parse and translate it into the database information.

According to still another embodiment, at 240, the GUI tool may also be used by the user to modify or augment existing settings for the RSS feed. So, the user may open existing settings for an existing RSS feed via the GUI tool. Appropriate fields of the GUI tool are populated with existing setting values. The use may then augment (add) settings and/or change (modify) settings. This is communicated via the GUI tool to the RSS database configuration service and the settings are augmented and/or modified accordingly. So, interaction between the GUI tool and the RSS database configuration service may not just to establish new settings for new RSS feeds; the interaction may also be to modify or augment existing settings for an existing RSS feed. Similarly, settings may be deleted when RSS feeds are removed.

The settings may also include authentication information when a particular RSS feed requires as much. By providing the authentication information via the settings, the subsequent database translation service can log into the RSS feed and authenticate in an automated fashion without manual interaction being necessary. The authentication information can include a variety of information such as, but not limited to, a cookie, a user identifier, a user password, a digital certificate, a digital signature, etc.

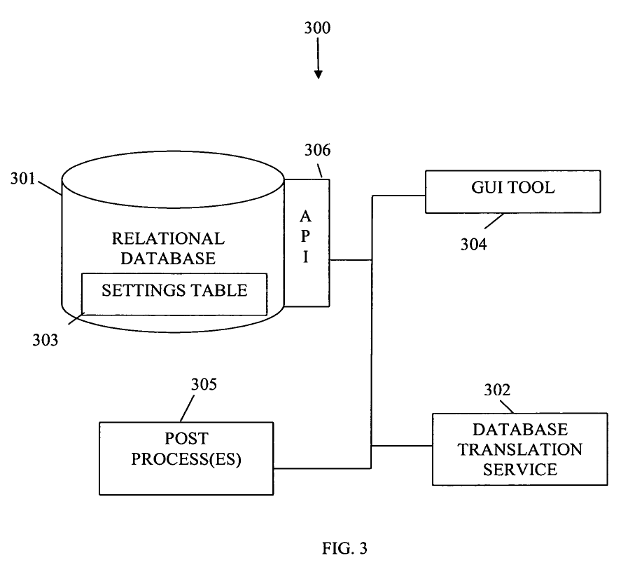

FIG. 3 is a diagram of a RSS and relational database integration system 300, according to an example embodiment. The RSS and relational database integration system 300 is implemented in a machine-accessible and readable medium and is operational over a network. The network may be wired, wireless, or a combination of wired and wireless. In an embodiment, portions of the RSS and relational database integration system 300 implements, among other things the RSS database integration service and the RSS database configuration service represented by the methods 100 and 200 of the FIGS. 1 and 2, respectively.

The RSS and relational database integration system 300 includes a relational database 301 and a database translation service 302. In some embodiments, the RSS and relational database integration system 300 may also include a settings table 303, a graphical user interface (GUI) tool 304, one or more post processes 305, and/or an Application Programming Interface (API) 306. Each of these and their interactions with one another will now be discussed in turn.

The relational database 301 resides in a machine-accessible medium or multiple media and can be accessed via other instructions that process on a machine.

Furthermore, the relational database 301 is to house RSS information that is translated into a relational database compatible data structure format. The relational database 301 may actually be a collection of databases organized as a data warehouse. According to an embodiment, the relational database 301 is the Teradata® product distributed by NCR Corporation of Dayton, Ohio.

The database translation service 302 also resides in a machine-accessible media and is operable to be executed on a machine (processing device).

The database translation service 302, when processed on the machine, translates RSS information into a data structure recognized and usable by the relational database 301. Techniques for achieving this were discussed above in detail with reference to the RSS database integration service represented by the method 100 of the FIG. 1.

According to an embodiment, the RSS and relational database integration system 300 may also include a settings table 303. The settings table 303 is implemented within a machine-accessible medium and is included within the relational database 301 as one of many tables and other structures housed within the relational database 301. The settings table 303 includes configuration information for the database translation service 302, which permits the database translation service 302 to acquire and translate RSS information into the data structure in an automated fashion. Example types of settings and usage for the settings were presented in detail above with reference to the method 200 of the FIG. 2.

In some cases, the RSS and relational database integration system 300 includes a GUI tool 304. The GUI tool 304 is implemented in a machine-accessible medium and is operable to or adapted to process on a machine and interacts with an end-user. The GUI tool 304 permits an end-user to supply the settings included in the settings table 302. This user interaction and the GUI tool 304 were discussed in detail above with reference to the method 200 of the FIG. 2.

In another case, the RSS and relational database integration system 300 includes one or more post processes 305. Each post process 305 operates against the data structure and its contents by accessing operations and applications associated with the relational database 301. The post processes 305 reside in a machine-accessible medium and are operable or adapted to process on a machine. Some example operations that may be achieved via a post process 305 include, but are not limited to, reporting, analytics, database mining, querying, merging, joining, etc. Descriptions of post processes 305 and how and when they may be invoked to process were discussed in detail above with reference to the method 100 of the FIG. 1.

In yet another situation, the RSS and relational database integration system 300 includes an API 306. The API 306 includes a variety of modules or callable operations/functions. The API 306 may include SQL and its available operations and user-defined and custom operations or modules. The operations or modules may be selectively processed in the machine-accessible medium on a machine using the data structure.

The data structure produced by the database translation service 302 may be a results table residing in the relational database 301, a database set residing in a machine-accessible medium, and/or a virtual results table or view residing in and accessible from the relational database 301.

It is now appreciated how tools and techniques may be used to automate the integration of RSS technology with relational database technology. These techniques permit enterprises and individuals having database management systems to fully leverage the benefits of RSS technology while maintaining and operating within their existing relational database environments.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving really simple syndication (RSS) information from an RSS feed;
translating selective elements of the RSS information into fields of a database table; and
making the database table available for use via an interface associated with a database.

2. The method of claim 1 further comprising, processing one or more automated applications against the database table to do more or more of the following: query the database table for specific information, extract specific information from the database table, generating a report in response to specific information detected in the database table, and performing custom analytics against specific information in the database table.

3. The method of claim 1, wherein receiving further includes acquiring a World-Wide Web (WWW) site for the RSS feed as a Uniform Resource Locator (URL) link for contacting the WWW site to acquire the RSS information.

4. The method of claim 1, wherein translating further includes using one or more of the following to assist in translating the selective elements into the fields of the database: an Extensible Markup Language (XML) Style Sheet (XSL), an XSL Transform (XSLT), an XML parser, and an XML Schema Definition (XSD).

5. The method of claim 1, wherein making further includes creating a persistent database table for the database table within the database.

6. The method of claim 1, wherein making further includes creating a temporary virtual database table for the database table within the database.

7. The method of claim 1 further comprising one or more of the following:
querying the database table;
deleting selective portions of the database table;
inserting additional information into selective fields of the database table;
modifying selective portions of the database table; and
merging or joining selective portions or the entire database table with other tables associated with the database.

8. A method, comprising:
presenting a graphical user interface (GUI) tool to a user for defining settings associated with a Really Simple Syndication (RSS) feed; and
associating a database translation service with the settings, wherein the database translation service processes upon receipt of RSS information acquired from the RSS feed, and wherein the RSS information is acquired in accordance with the settings, and the database translation service is to translate the RSS information into database information accessible and usable in a relational database.

9. The method of claim 8 further comprising, storing the settings in a table of the relational database.

10. The method of claim 8 further comprising, receiving additional settings for one or more additional RSS feeds via the GUI tool.

11. The method of claim 10 further comprising, identifying the settings as one or more of the following a RSS feed name, a RSS Uniform Resource Locator (URL) link, a RSS version number, and a custom service to apply as a preprocess against the RSS information when acquired from the RSS feed.

12. The method of claim 8 further comprising, identifying selective elements in the settings for identifying selective portions of the RSS information to include in the database information when the database translation service acquires the RSS information from the RSS feed.

13. The method of claim 8 further comprising, modifying or augmenting the settings received from the GUI tool with additional information.

14. The method of claim 8 further comprising, identifying a log file identifier in the settings for the database translation service to record log, history, or transaction details associated with acquiring the RSS information from the RSS feed.

15. A system comprising:
a relational database residing in a machine accessible medium; and
a database translation service residing in the machine accessible medium, wherein the database translation service is to translate Really Simple Syndication (RSS) information into a data structure recognized within the relational database.

16. The system of claim 15 further comprising, a settings table residing in the relational database, wherein the settings table is to include settings to acquire the RSS information from an external RSS feed.

17. The system of claim 16 further comprising, a Graphical User Interface (GUI) tool residing in the machine accessible medium to interact with a user and to receive the settings from the user that define an RSS feed used to acquire the RSS information.

18. The system of claim 15, wherein the data structure is one or more of the following: a results table residing in the relational database, a database set residing in the machine accessible medium, and a virtual results table residing in the relational database.

19. The system of claim 15 further comprising, one or more post processes residing in the machine accessible medium to process on a machine using the data structure in order to perform one or more of the following: reporting, analytics, and mining against the relational database.

20. The system of claim 15 further comprising, an Application Programming Interface (API) residing in the machine accessible medium, wherein the API includes one or more operations that can be selective processed on a machine using the data structure.
